(19) United States
(12) Patent Application Publication
(10) Pub. No.: US 2024/0051577 A1
(43) Pub. Date: Feb. 15, 2024

(54) VEHICLE CONTROL DEVICE, VEHICLE CONTROL METHOD, AND STORAGE MEDIUM

(71) Applicant: HONDA MOTOR CO., LTD., Minato-ku, Tokyo (JP)

(72) Inventors: Sho Hitakatsu, Wako-shi, Saitama (JP); Toshikazu Suwa, Tokyo (JP); Masaki Nakajima, Yokohama-shi (JP)

(21) Appl. No.: 18/269,295

(22) PCT Filed: Dec. 28, 2020
(86) PCT No.: PCT/JP2020/049101

§ 371 Date: Jun. 23, 2023

(51) Int. Cl. B60W 60/00

(52) U.S. Cl. CPC B60W 60/0018; B60W 2520/06; B60W 2552/53; B60W 2556/20; B60W 2556/40; B60W 2556/60

(57) ABSTRACT

A vehicle control device is a vehicle control device that controls autonomous driving of a vehicle, the vehicle control device including a calculator that calculates an index value indicating accuracy of an estimated position of the vehicle according to a current running state of the vehicle and an estimated running state of the vehicle which is estimated in the control of the autonomous driving, and a controller that lowers a control level of the autonomous driving when the calculated index value is equal to or greater than a predetermined threshold value.

### TECHNICAL FIELD

The present invention relates to a vehicle control device, a vehicle control method, and a program.

### BACKGROUND ART

In the related art, there is known an autonomous driving executability notification system that gives a notification of executability of autonomous driving by repeatedly determining whether there is high-precision map information necessary for autonomous driving for roads through which a vehicle has passed (see, for example, Patent Document 1).

### CITATION LIST

### Patent Document

### [Patent Document 1]

Japanese Unexamined Patent Application, First Publication No. 2018-189594

### SUMMARY OF INVENTION

### Technical Problem

In the related art, the presence or absence of high-precision map information is a criterion for determining whether or not autonomous driving can be performed, which assumes that the estimated position of a vehicle estimated in a system is accurate. For this reason, in a case where there is an unintentional discrepancy between the estimated position of the vehicle and the actual position of the vehicle, it is not possible to determine whether autonomous driving can be performed, which may hinder driving.

The present invention has been made in consideration of such circumstances, and an object thereof is to provide a vehicle control device that can accurately grasp a running state of a vehicle and change a control level of autonomous driving under appropriate conditions, a vehicle control method, and a program.

### Solution to Problem

A vehicle control device, a vehicle control method, and a program according to the present invention adopt the following configurations.

(1) A vehicle control device according to one aspect of the present invention is a vehicle control device that controls autonomous driving of a vehicle, the vehicle control device including a calculator configured to calculate an index value indicating accuracy of an estimated position of the vehicle according to a current running state of the vehicle and an estimated running state of the vehicle which is estimated in the control of the autonomous driving, and a controller configured to lower a control level of the autonomous driving when the calculated index value is equal to or greater than a predetermined threshold value.

According to an aspect (2), in the vehicle control device according to the aspect (1), the calculator calculates an angle formed by a current traveling direction of the vehicle and a traveling direction of a target trajectory which is set in the control of the autonomous driving as the index value, and the controller lowers the control level of the autonomous driving when the calculated angle is equal to or greater than a predetermined threshold value.

According to an aspect (3), in the vehicle control device according to the aspect (1), the calculator calculates an angle formed by a current traveling direction of the vehicle and a traveling direction of a recommended lane in the control of the autonomous driving as the index value, and the controller lowers the control level of the autonomous driving when the calculated angle is equal to or greater than a predetermined threshold value.

According to an aspect (4), in the vehicle control device according to the aspect (1), the calculator calculates an angle formed by a current traveling direction of the vehicle and a traveling direction of a running lane recognized according to surrounding information of the vehicle in the control of the autonomous driving as the index value, and the controller lowers the control level of the autonomous driving when the calculated angle is equal to or greater than a predetermined threshold value.

According to an aspect (5), in the vehicle control device according to any one of the aspects (2) to (4), the calculator calculates the current traveling direction of the vehicle according to radio waves arriving from a satellite.

According to an aspect (6), in the vehicle control device according to the aspect (1), the calculator calculates a distance between a current position of the vehicle and the estimated position of the vehicle on a map estimated in the control of the autonomous driving as the index value, and the controller lowers the control level of the autonomous driving when the calculated distance is equal to or greater than a predetermined threshold value.

According to an aspect (7), in the vehicle control device according to the aspect (6), the calculator calculates the current position of the vehicle according to radio waves arriving from a satellite.

(8) A vehicle control method according to another aspect of the present invention causes a computer mounted on a vehicle to calculate an index value indicating accuracy of an estimated position of the vehicle according to a current running state of the vehicle and an estimated running state of the vehicle which is estimated in the control of the autonomous driving of the vehicle, and lower a control level of the autonomous driving when the calculated index value is equal to or greater than a predetermined threshold value.

(9) A program according to still another aspect of the present invention causes a computer mounted on a vehicle to calculate an index value indicating accuracy of an estimated position of the vehicle according to a current running state of the vehicle and an estimated running state of the vehicle which is estimated in the control of the autonomous driving of the vehicle, and lower a control level of the autonomous driving when the calculated index value is equal to or greater than a predetermined threshold value.

### Advantageous Effects of Invention

According to the above aspects, it is possible to accurately grasp a running state of a vehicle and change the control level of autonomous driving under appropriate conditions.

### BRIEF DESCRIPTION OF DRAWINGS

FIG. 1 is a configuration diagram of a vehicle system using a vehicle control device according to an embodiment.

FIG. 2 is a functional configuration diagram of a first controller and a second controller according to the embodiment.

FIG. 3 is a diagram showing an example of a correspondence relationship between a driving mode, a host vehicle control state, and a task according to the embodiment.

FIG. 4 is a flowchart showing an example of abnormality determination processing performed by a first controller 120 according to the embodiment.

FIG. 5 is a diagram showing an example of a scene in which an abnormality occurs in a running state of host vehicle M in the embodiment.

FIG. 6 is a flowchart showing another example of abnormality determination processing performed by the first controller 120 according to the embodiment.

FIG. 7 is a diagram showing another example of a scene in which an abnormality occurs in a running state of the host vehicle M in the embodiment.

### DESCRIPTION OF EMBODIMENTS

An embodiment of a vehicle control device, a vehicle control method, and a program of the present invention will be described below with reference to the drawings.

[Overall Configuration]

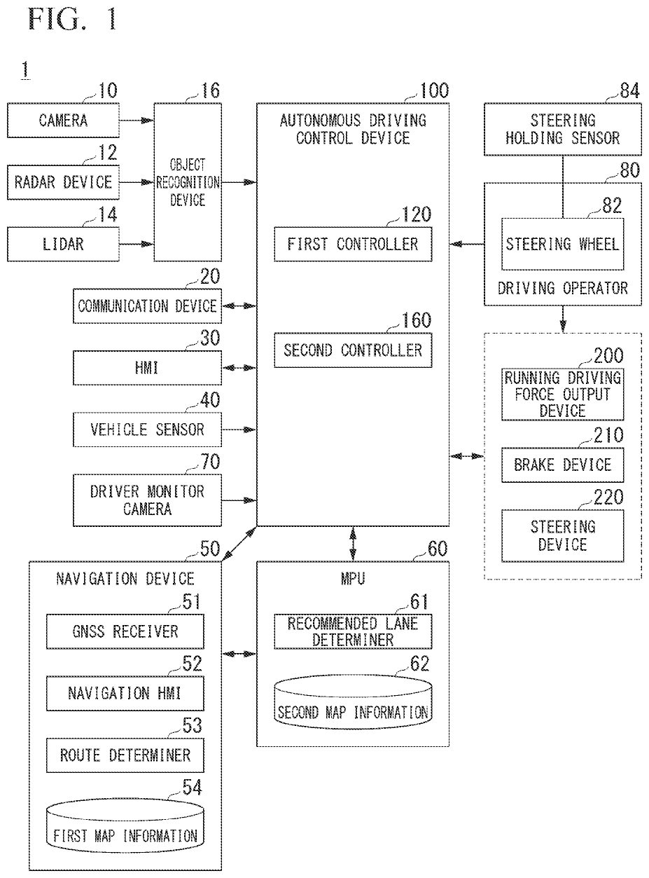

FIG. 1 is a configuration diagram of a vehicle system 1 using a vehicle control device according to an embodiment. A vehicle on which the vehicle system 1 is mounted is, for example, a two-wheeled, three-wheeled, or four-wheeled vehicle, and its drive source is an internal combustion engine such as a diesel engine or a gasoline engine, an electric motor, or a combination thereof. The electric motor operates using electric power generated by a generator connected to the internal combustion engine, or electric power discharged from a secondary battery or a fuel cell.

The vehicle system 1 includes, for example, a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driver monitor camera 70, a driving operator 80, an autonomous driving control device 100, a running driving force output device 200, a brake device 210, and a steering device 220. These devices and equipment are connected to each other by multiplex communication lines such as a controller area network (CAN) communication lines, serial communication lines, wireless communication networks, or the like. Note that the configuration shown in FIG. 1 is merely an example, a portion of the configuration may be omitted, or another configuration may be added.

The camera 10 is, for example, a digital camera using a solid-state imaging element such as a charge coupled device (CCD) or a complementary metal oxide semiconductor (CMOS). The camera 10 is attached to any location of a vehicle (hereinafter referred to as a host vehicle M) on which the vehicle system 1 is mounted. In a case where the front is imaged, the camera 10 is attached to an upper portion of a front windshield, a rear surface of a rearview mirror, or the like. For example, the camera 10 periodically and repeatedly images the surroundings of the host vehicle M. The camera 10 may be a stereo camera.

The radar device 12 radiates radio waves such as millimeter waves to the surroundings of the host vehicle M, and detects radio waves (reflected waves) reflected by an object to detect at least the position (distance and direction) of the object. The radar device 12 can be attached to any location on the host vehicle M. The radar device 12 may detect the position and speed of the object by a frequency modulated continuous wave (FM-CW) method.

The LIDAR 14 irradiates the surroundings of the host vehicle M with light (or electromagnetic waves with wavelengths close to light) and measures scattered light. The LIDAR 14 detects the distance to a target according to a period of time from light emission to light reception. The emitted light is, for example, pulsed laser light. The LIDAR 14 is attached to any location of the host vehicle M.

The object recognition device 16 performs sensor fusion processing on detection results obtained by some or all of the camera 10, the radar device 12, and the LIDAR 14 to recognize the position, type, speed, and the like of the object. The object recognition device 16 outputs recognition results to the autonomous driving control device 100. The object recognition device 16 may output detection results obtained by the camera 10, the radar device 12, and the LIDAR 14 to the autonomous driving control device 100 as they are. The recognition device 16 may be omitted from the vehicle system 1.

The communication device 20 communicates with another vehicle existing in the vicinity of the host vehicle M or communicates with various server devices via wireless base stations by using, for example, a cellular network, a Wi-Fi network, Bluetooth (registered trademark), dedicated short range communication (DSRC), or the like.

The HMI 30 presents various information to an occupant of the host vehicle M and receives input operations by the occupant. The HMI 30 includes various display devices, a speaker, a buzzer, a touch panel, a switch, keys, and the like.

The vehicle sensor 40 includes a vehicle speed sensor that detects the speed of the host vehicle M, an acceleration sensor that detects an acceleration, a direction sensor that detects the direction of the host vehicle M, and the like.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory.

The GNSS receiver 51 specifies the position of the host vehicle M according to signals received from GNSS satellites (radio waves arriving from artificial satellites). The position of the host vehicle M may be specified or complemented by an inertial navigation system (INS) using the output of the vehicle sensor 40. The navigation HMI 52 includes a display device, a speaker, a touch panel, keys, and the like. The navigation HMI 52 may be partially or entirely shared with the HMI 30 described above. For example, the route determiner 53 determines a route from the position of the host vehicle M which is specified by the GNSS receiver 51 (or any input position) to a destination input by the occupant using the navigation HMI 52 (hereinafter referred to as a route on a map) is determined with reference to the first map information 54.

The first map information 54 is, for example, information in which road shapes are represented by links indicating roads and nodes connected by the links. The first map information 54 may include a road curvature, point of interest (POI) information, and the like. The route on the map is output to the MPU 60. The navigation device 50 may provide route guidance using the navigation HMI 52 according to the route on the map. The navigation device 50 may be realized, for example, by the function of a terminal device such as a smartphone or a tablet terminal owned by the occupant. The navigation device 50 may transmit the current position and the destination to a navigation server via the communication device 20 and acquire a route equivalent to the route on the map from the navigation server.

The MPU 60 includes, for example, a recommended lane determiner 61, and holds second map information 62 in a storage device such as an HDD or a flash memory. The recommended lane determiner 61 is realized by a hardware processor (computer) such as a central processing unit (CPU) executing a program (software). In addition, the recommended lane determiner 61 may be realized by hardware (circuitry) such as a large-scale integration (LSI), an application specific integrated circuit (ASIC), a field-programmable gate array (FPGA), a graphics processing unit (GPU) or may be realized by cooperation of software and hardware. The program may be stored in the storage device of the MPU 60 (a storage device having a non-transitory storage medium) in advance, may be stored in a detachable storage medium such as a DVD or a CD-ROM, or may be installed in the storage device of the MPU 60 by mounting a storage medium (non-transitory storage medium) on a drive device.

The recommended lane determiner 61 determines a recommended lane for each block by dividing the route on the map provided from the navigation device 50 into a plurality of blocks (for example, dividing the route on the map by 100 [m] in a vehicle traveling direction) and referring to the second map information 62. The recommended lane determiner 61 determines which lane from the left to run. In a case where there is a branch location on the route on the map, the recommended lane determiner 61 determines a recommended lane so that the host vehicle M can run along a rational route to a branch destination.

The second map information 62 is map information that is more accurate than the first map information 54. The second map information 62 includes, for example, lane center information or lane boundary information. Further, the second map information 62 includes road information, traffic control information, address information (address/zip code), facility information, telephone number information, information on a prohibition section where a mode A or a mode B is prohibited, and the like. The second map information 62 may be updated at any time by the communication device 20 communicating with other devices.

The driver monitor camera 70 is, for example, a digital camera using a solid-state imaging element such as a CCD or a CMOS. The driver monitor camera 70 is attached to any location in the host vehicle M at a position and direction in which the head of an occupant sitting on a driver's seat of the host vehicle M (hereinafter referred to as a driver) from the front (in a direction in which the face is imaged). For example, the driver monitor camera 70 is attached to an upper portion of the display device provided in the central portion of an instrument panel of the host vehicle M.

The driving operator 80 includes, for example, an accelerator pedal, a brake pedal, a shift lever, and other operators in addition to a steering wheel 82. A sensor for detecting the amount of operation or the presence or absence of an operation is attached to the driving operator 80. A detection result of the sensor is output to the autonomous driving control device 100, or is output to some or all of the running driving force output device 200, the brake device 210, and the steering device 220. The steering wheel 82 is an example of an “operator for receiving a steering operation by the driver”. The steering wheel 82 does not need to be annular, and may be in the form of a modified steering wheel, a joystick, a button, or the like. A steering holding sensor 84 is attached to the steering wheel 82. The steering holding sensor 84 is realized by a capacitance sensor or the like, and outputs a signal (meaning that the driver is in contact with the steering wheel 82 in a state where a force is applied) for detecting whether or not the driver is holding the steering wheel 82 to the autonomous driving control device 100.

The autonomous driving control device 100 includes, for example, a first controller 120 and a second controller 160. The first controller 120 and the second controller 160 are realized by, for example, a hardware processor (computer) such as a CPU executing a program (software). In addition, some or all of these components may be realized by hardware (circuitry) such as LSI, ASIC, FPGA, or GPU or may be realized by cooperation of software and hardware. The program may be stored in a storage device (a storage device including a non-transitory storage medium) such as the HDD or the flash memory of the autonomous driving control device 100 in advance, may be stored in a detachable storage medium such as a DVD or a CD-ROM, or may be installed in the HDD or the flash memory of the autonomous driving control device 100 by mounting a storage medium (non-transitory storage medium) to the drive device.

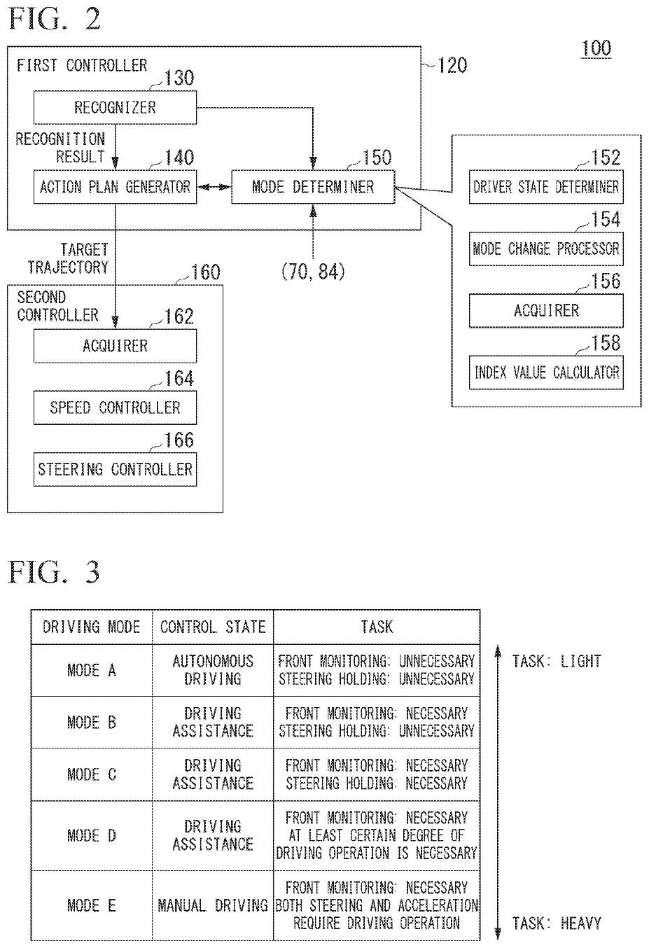

FIG. 2 is functional configuration diagrams of the first controller 120 and the second controller 160. The first controller 120 includes, for example, a recognizer 130, an action plan generator 140, and a mode determiner 150. The autonomous driving control device 100 is an example of a “vehicle control device”.

The first controller 120 realizes, for example, a function according to artificial intelligence (AI) and a function according to a model given in advance in parallel. For example, a function of “recognizing intersections” may be realized by performing recognition of intersections by deep learning or the like and recognition according to predetermined conditions (signals that can be pattern-matched, road markings, and the like) in parallel and scoring and comprehensively evaluating both of them. Thereby, the reliability of autonomous driving is secured.

The recognizer 130 recognizes the state of an object in the vicinity of the host vehicle M such as the position, speed, and acceleration of the object according to information input from the camera 10, the radar device 12, and the LIDAR 14 via the object recognition device 16. The position of the object is recognized as a position on absolute coordinates, for example, with a representative point (the center of gravity, the center of a drive shaft, or the like) of the host vehicle M as the origin and is used for control. The position of the object may be represented by a representative point such as the center of gravity or a corner of the object, or may be represented by a region. The “state” of the object may include the acceleration or jerk of the object, or an “action state” (for example, whether the object is changing lanes or about to change lanes).

Further, the recognizer 130 recognizes, for example, the lane in which the host vehicle M is running (running lane). For example, the recognizer 130 recognizes a running lane by comparing a pattern of road division lines obtained from the second map information 62 (for example, an array of solid lines and broken lines) and a pattern of road division lines around the host vehicle M recognized from images captured by the camera 10 with each other. Note that the present invention is not limited to the road division lines, and the recognizer 130 may recognize the running lane by recognizing running road boundaries (road boundaries) including road division lines, road shoulders, curbs, medians, guardrails, and the like. In this recognition, the position of the host vehicle M acquired from the navigation device 50 and processing results obtained by the INS may be taken into consideration. The recognizer 130 also recognizes stop lines, obstacles, red lights, toll gates, and other road events.

The recognizer 130 recognizes the position and posture of the host vehicle M with respect to the running lane when recognizing the running lane. For example, the recognizer 130 may recognize the deviation of a reference point of the host vehicle M from the center of the lane and an angle formed with respect to a line connecting the center of the lane in the traveling direction of the host vehicle M as a relative position of the host vehicle M with respect to the running lane and a posture. Instead, the recognizer 130 may recognize the position of the reference point of the host vehicle M with respect to any one side edge (a road division line or a road boundary) of the running lane, or the like as the relative position of the host vehicle M with respect to the running lane.

In principle, the action plan generator 140 runs along a recommended lane determined by the recommended lane determiner 61, and further generates a target trajectory on which the host vehicle M will automatically (without depending on the operation of the driver) run in the future so as to be able to cope with the circumstances around the host vehicle M. The target trajectory includes, for example, speed elements. For example, the target trajectory is represented by arranging points (trajectory points) to be reached by the host vehicle M in order. The trajectory point is a point to be reached by the host vehicle M for each predetermined running distance (for example, approximately several [m]) along the road, and apart from this, a target speed and a target acceleration for each predetermined sampling time (for example, approximately 0 commas [sec]) are generated as parts of the target trajectory. In addition, the trajectory point may be a position to be reached by the host vehicle M at each predetermined sampling time. In this case, information on the target speed and the target acceleration is represented by intervals between the trajectory points.

The action plan generator 140 may set autonomous driving events when generating the target trajectory. The autonomous driving events include a constant-speed driving event, a low-speed following driving event, a lane change event, a branching event, a merging event, a takeover event, and the like. The action plan generator 140 generates a target trajectory corresponding to an activated event.

The mode determiner 150 determines a driving mode of the host vehicle M to be any one of a plurality of driving modes with different tasks imposed on the driver. The mode determiner 150 includes, for example, a driver state determiner 152, a mode change processor 154, an acquirer 156, and an index value calculator 158. These individual functions will be described below. The mode change processor 154 is an example of a “controller”. The index value calculator 158 is an example of a “calculator”. Alternatively, a combination of the index value calculator 158 and the GNSS receiver 51 is an example of a “calculator”.

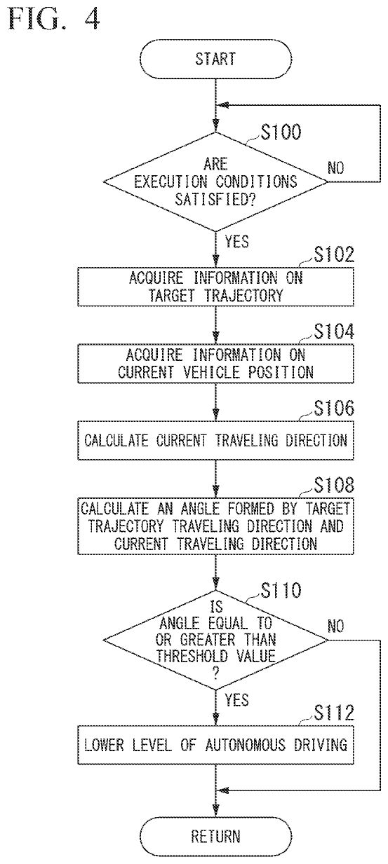

FIG. 3 is a diagram showing an example of a correspondence relationship between a driving mode, a control state of the host vehicle M, and a task. Regarding the driving mode of the host vehicle M, for example, there are five modes from a mode A to a mode E. The control state, that is, the degree of automation (control level) of driving control of the host vehicle M is highest in the mode A, is followed by the mode B, the mode C, and the mode D in descending order, and is lowest in the mode E. In contrast, the task imposed on the driver is lightest in the mode A, is followed by the mode B, the mode C, the mode D in ascending order, and is most severe in the mode E. Note that, since the control state is not autonomous driving in the modes D and E, the autonomous driving control device 100 is responsible for terminating control related to autonomous driving and transitioning to driving assistance or manual driving. Exemplary examples of the contents of each driving mode are shown below.

In the mode A, the vehicle is set to be in an autonomous driving state, and neither front monitoring or holding of the steering wheel 82 (steering holding in the drawing) is imposed on the driver. However, even in the mode A, the driver is required to be in a posture that can rapidly transition to manual driving in response to a request from the system centered on the autonomous driving control device 100. Note that the term “autonomous driving” as used herein means that both steering and acceleration/deceleration are controlled independently of the driver's operation. The front means a space in the traveling direction of the host vehicle M which is visually recognized through the front windshield. The mode A is, for example, a driving mode which is executable when a condition, such as a condition in which the host vehicle M is running at a predetermined speed (for example, approximately 50 [km/h]) or less or a condition in which there is a preceding vehicle to be followed, is satisfied on a motorway such as a highway, and may be referred to as a traffic jam pilot (TJP). In a case where this condition is no longer satisfied, the mode determiner 150 changes the driving mode of the host vehicle M to the mode B.

In the mode B, the vehicle is set to be in a driving assistance state, and a task of monitoring the front of the host vehicle M (hereinafter referred to as front monitoring) is imposed on the driver, but a task of holding the steering wheel 82 is not imposed on the driver. In the mode C, the vehicle is set to be in a driving assistance state, and a task of monitoring the front of the host vehicle M and a task of holding the steering wheel 82 are imposed on the driver. The mode D is a driving mode in which at least one of steering and acceleration/deceleration of the host vehicle M requires a certain amount of driving operation by the driver. For example, in the mode D, driving assistance such as adaptive cruise control (ACC) and a lane keeping assist system (LKAS) is performed. In the mode E, the vehicle is set to be in a manual driving state in which the driver's driving operation is required for both steering and acceleration/deceleration. In both the mode D and the mode E, a task of monitoring the front of the host vehicle M is naturally imposed on the driver.

The autonomous driving control device 100 (and a driving assistance device (not shown)) executes an automatic lane change corresponding to a driving mode. The automatic lane change includes an automatic lane change (1) requested by the system and an automatic lane change (2) requested by the driver. The automatic lane change (1) includes an automatic lane change for overtaking and an automatic lane change for advancing toward a destination (an automatic lane change due to a change in recommended lane), which are performed when the speed of a preceding vehicle is lower than the speed of the host vehicle by a standard or more. In the automatic lane change (2), when the driver operates a direction indicator while conditions regarding the speed, the positional relationship with the surrounding vehicles, and the like are satisfied, the host vehicle M changes lanes in the direction of operation.

In the mode A, the autonomous driving control device 100 does not perform any of the automatic lane change (1) and the automatic lane change (2). In the modes B and C, the autonomous driving control device 100 executes both the automatic lane change (1) and the automatic lane change (2). In the mode D, the driving assistance device (not shown) executes the automatic lane change (2) without executing the automatic lane change (1). In the mode E, neither the automatic lane change (1) nor the automatic lane change (2) is executed.

The mode determiner 150 changes the driving mode of the host vehicle M to a driving mode with a more severe task in a case where when the driver does not execute a task related to the determined driving mode (hereinafter referred to as the current driving mode).

For example, in the mode A, when the driver is in a posture that cannot transition to manual driving in response to a request from the system (for example, when looking aside outside an allowable area is continued, or when a sign of difficulty of driving has been detected), the mode determiner 150 performs control of prompting the driver to transition to manual driving by using the HMI 30 and bringing the host vehicle M to the shoulder of the road to gradually stop the host vehicle M and stop the autonomous driving when the driver does not respond. After the autonomous driving is stopped, the host vehicle enters the state of the mode D or E, and the host vehicle M can be started by the driver's manual operation. Hereinafter, the same applies to “stopping autonomous driving”. In a case where the driver is not monitoring the front in the mode B, the mode determiner 150 performs control of prompting the driver to monitor the front using the HMI 30 and bringing the host vehicle M to the shoulder of the road to gradually stop the host vehicle M and stop the autonomous driving when the driver does not respond. In a case where the driver is not monitoring the front or is not holding the steering wheel 82 in the mode C, the mode determiner 150 performs control of prompting the driver to monitor the front using the HMI 30 or to hold the steering wheel 82 and bringing the host vehicle M to the shoulder of the road to gradually stop the host vehicle M and stop the autonomous driving when the driver does not respond.

The driver state determiner 152 monitors the driver's state for the above-described mode change and determines whether the driver's state is a state corresponding to a task. For example, the driver state determiner 152 analyzes an image captured by the driver monitor camera 70 to perform posture estimation processing, and determines whether the driver is in a posture that cannot transition to manual driving in response to a request from the system. Further, the driver state determiner 152 analyzes an image captured by the driver monitor camera 70 to perform line-of-sight estimation processing, and determines whether the driver is monitoring the front.

The mode change processor 154 performs a variety of processing for mode change. For example, the mode change processor 154 instructs the action plan generator 140 to generate a target trajectory for stopping at the shoulder of the road, instructs a driving assistance device (not shown) to operate, or controls the HMI 30 in order to prompt the driver to perform an action. In addition, the mode change processor 154 lowers the control level when an index value calculated by the index value calculator 158, which will be described later, is equal to or greater than a predetermined threshold value (hereinafter simply referred to as a “threshold value or more”) or is greater than the threshold value.

The acquirer 156 acquires information on the target trajectory (trajectory point) generated by the action plan generator 140, information on an estimated position of the host vehicle M which is specified by the action plan generator 140 (hereinafter referred to as an “estimated vehicle position”), information on a recommended lane determined by the recommended lane determiner 61, information on the position of the host vehicle M which is measured by the GNSS receiver 51, information on a running lane recognized by the recognizer 130, and the like.

The index value calculator 158 calculates an index value indicating the accuracy of the estimated vehicle position of the host vehicle M according to the current running state of the host vehicle M and the estimated running state of the host vehicle M which is estimated in the autonomous driving control of the autonomous driving control device 100. For example, the estimated vehicle position is the current position of the host vehicle M on the target trajectory determined by the action plan generator 140 (a position on the second map information 62). The estimated vehicle position may be the current position of the host vehicle M on the recommended lane determined by the recommended lane determiner 61 of the MPU 60 or may be the current position of the host vehicle M on the running lane recognized by the recognizer 130.

The index value calculator 158 calculates a traveling direction according to the traveling direction of the target trajectory generated by the action plan generator 140 (hereinafter referred to as a “target trajectory traveling direction”) and the traveling direction of the host vehicle M calculated according to a change in the current position of the host vehicle M which is measured by the GNSS receiver 51 (hereinafter referred to as a “current traveling direction”). For example, the index value calculator 158 calculates an angle (difference) between the target trajectory traveling direction and the current traveling direction as an index value. Alternatively, the index value calculator 158 may calculate an angle formed by the traveling direction of the recommended lane determined by the recommended lane determiner 61 and the current traveling direction as an index value. Alternatively, the index value calculator 158 may calculate an angle formed by the traveling direction of the running lane recognized by the recognizer 130 and the current traveling direction as an index value. The above-mentioned angle is an example of the “index value”.

That is, the index value calculator 158 calculates an angle formed by the current traveling direction of the host vehicle M and the traveling direction of the target trajectory which is set in the autonomous driving control as an index value, and the mode change processor 154 lowers the control level of autonomous driving when the calculated angle is equal to or greater than a predetermined threshold value. In addition, the index value calculator 158 calculates an angle formed by the current traveling direction of the host vehicle M and the traveling direction of the recommended lane in autonomous driving control as an index value, and the mode change processor 154 lowers the control level of autonomous driving when the calculated angle is equal to or greater than a predetermined threshold value. In addition, the index value calculator 158 calculates an angle formed between the current traveling direction of the host vehicle M and the traveling direction of the running lane which is recognized according to the surrounding information of the host vehicle M in autonomous driving control as an index value, and the mode change processor 154 lowers the control level of autonomous driving when the calculated angle is equal to or greater than a predetermined threshold value. The index value calculator 158 calculates the current traveling direction of the host vehicle M according to radio waves arriving from a satellite.

The index value calculator 158 calculates an index value according to the estimated vehicle position and the current position of the host vehicle M which is measured by the GNSS receiver 51 (hereinafter referred to as a “current vehicle position”). For example, the index value calculator 158 calculates the distance (the difference, the positional deviation) between the estimated vehicle position and the current vehicle position as an index value. The above-described distance is an example of the “index value”.

That is, the index value calculator 158 calculates a distance between the current position of the host vehicle M and the estimated position of the host vehicle M on a high-precision map which is estimated in autonomous driving control as an index value, and the mode change processor 154 lowers the control level of autonomous driving when the calculated distance is equal to or greater than a predetermined threshold value.

Returning back to FIG. 2, the second controller 160 controls the running driving force output device 200, the brake device 210, and the steering device 220 so that the host vehicle M passes the target trajectory generated by the action plan generator 140 at a scheduled time.

The second controller 160 includes, for example, an acquirer 162, a speed controller 164, and a steering controller 166. The acquirer 162 acquires information on the target trajectory (trajectory point) generated by the action plan generator 140 and stores it in a memory (not shown). The speed controller 164 controls the running driving force output device 200 or the brake device 210 according to speed elements associated with the target trajectory stored in the memory. The steering controller 166 controls the steering device 220 in accordance with the curved state of the target trajectory stored in the memory. The processing of the speed controller 164 and the steering controller 166 is realized by, for example, a combination of feedforward control and feedback control. As an example, the steering controller 166 executes feedforward control according to the curvature of the road in front of the host vehicle M and feedback control according to a deviation from the target trajectory in combination.

The running driving force output device 200 outputs a running driving force (torque) for running the vehicle to drive wheels. The running driving force output device 200 includes, for example, a combination of an internal combustion engine, an electric motor, and a transmission, and an electronic control unit (ECU) that controls them. The ECU controls the above-described configuration in accordance with information input from the second controller 160 or information input from the driving operator 80.

The brake device 210 includes, for example, a brake caliper, a cylinder that transmits hydraulic pressure to the brake caliper, an electric motor that generates hydraulic pressure in the cylinder, and a brake ECU. The brake ECU controls the electric motors in accordance with information input from the second controller 160 or information input from the driving operator 80 so that a brake torque corresponding to a braking operation is output to each wheel. The brake device 210 may include a mechanism that transmits hydraulic pressure generated by operating a brake pedal included in the driving operator 80 to the cylinders via a master cylinder as a backup. Note that the brake device 210 is not limited to the configuration described above, and may be an electronically controlled hydraulic brake device that controls an actuator in accordance with information input from the second controller 160 to transmit the hydraulic pressure of the master cylinder to the cylinder.

The steering device 220 includes, for example, a steering ECU and an electric motor. For example, the electric motor applies a force to a rack and pinion mechanism to change the orientation of steered wheels. The steering ECU drives the electric motor in accordance with information input from the second controller 160 or information input from the driving operator 80 to change the orientation of the steered wheels.

[Abnormality Determination Processing (1) Performed by First Controller]

Abnormality determination processing performed by the first controller 120 will be described below using a flowchart. For example, an abnormality means that an estimated vehicle position of the host vehicle M is deviated from the actual position of the host vehicle M, and it is necessary to change the control level of autonomous driving. Conceivable causes of the abnormality include, for example, an abnormality of positioning data that is the original data used for estimating the estimated vehicle position of the host vehicle M (positioning data that cannot be obtained, low accuracy of the positioning data, and the like), an abnormality of a high-precision map, and the like. The abnormality of the positioning data may occur, for example, when a hardware or software failure occurs in the GNSS receiver 51, when the host vehicle M is running in a place where other radio waves having the same frequency band as radio waves of a GNSS satellite are being transmitted, when a failure occurs in a GNSS satellite (for example, a quasi-zenith satellite or the like), or the like. The abnormality of the high-precision map may occur when information on newly opened roads is not reflected, when map information data is incorrect or missing, or the like.

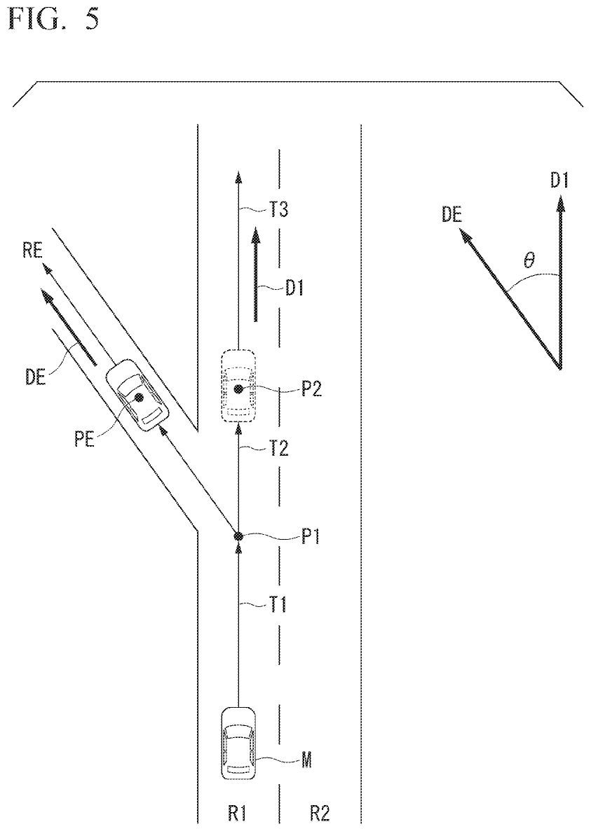

FIG. 4 is a flowchart showing an example of abnormality determination processing performed by the first controller 120. FIG. 5 is a diagram showing an example of a scene in which an abnormality occurs in a running state of the host vehicle M. In the following description, it is assumed that the host vehicle M is running in a driving mode determined by the mode determiner 150 (for example, the mode A or the mode B) under autonomous driving control along a target trajectory generated by the action plan generator 140. In addition, a case where information on the target trajectory generated by the action plan generator 140 is used to calculate an index value will be described as an example.

First, the mode determiner 150 waits until execution conditions are satisfied (step S100). The execution conditions are conditions for executing the abnormality determination processing of this flowchart and include the following various conditions.

Condition (i): The autonomous driving control device 100 can acquire second map information 62 from the MPU 60.
Condition (ii): The host vehicle M is not running in a prohibited section for the mode A or the mode B.
Condition (iii): No abnormality occurs in processing using the second map information 62 in the autonomous driving control device 100.

When the execution conditions are satisfied, the acquirer 156 of the mode determiner 150 acquires information on the target trajectory of the host vehicle M which is generated by the action plan generator 140 (step S102).

Furthermore, the acquirer 156 acquires information on the current vehicle position of the host vehicle M which is measured by the GNSS receiver 51 (step S104).

Next, the index value calculator 158 calculates the current traveling direction of the host vehicle M according to the acquired information on the current vehicle position of the host vehicle M (step S106). For example, the index value calculator 158 calculates the current traveling direction of the host vehicle M according to changes in the current vehicle position of the host vehicle M over time. Note that the current traveling direction is calculated using the latest current vehicle position of the host vehicle M which is measured by the GNSS receiver 51, and thus it can be estimated as the accurate current traveling direction of the host vehicle M.

Next, the index value calculator 158 calculates an angle formed by a target trajectory traveling direction according to the acquired target trajectory and the calculated current traveling direction (step S108). The example shown in FIG. 5 shows a scene in which the host vehicle M running along target trajectories T1, T2, and T3 set on a road R1 under autonomous driving control unintentionally deviates from the target trajectory at a point P1 and enters a road RE located on the left in a traveling direction. That is, the host vehicle M, which should have been positioned at a point P2 on the road R1 when the host vehicle M has been normally running along the target trajectory under autonomous driving control is actually positioned at a point PE on the road RE. In this example, a target trajectory traveling direction at the point P2 is a direction D1, and the current traveling direction at the point PE is a direction DE. In this case, the index value calculator 158 calculates an angle θ formed by the target trajectory traveling direction D1 and the current traveling direction DE.

Next, the mode change processor 154 determines whether the calculated angle θ is equal to or greater than a predetermined threshold value (step S110). The threshold value is set to a value with which it can be determined that the vehicle is running on a different road. When the calculated angle θ is equal to or greater than the threshold value, it can be determined that the vehicle is running on a different road (that is, it can be determined that there is a deviation between the estimated vehicle position and the current vehicle position and that an abnormality has occurred). On the other hand, when the calculated angle θ is not equal to or greater than the threshold value, it can be determined that the vehicle is running on the same road (that is, it can be determined that there is no deviation between the estimated vehicle position and the current vehicle position, and that no abnormality has occurred). When the mode change processor 154 determines that the calculated angle θ is not equal to or greater than the predetermined threshold value, the mode change processor 154 continues controlling the autonomous driving control in the current driving mode without changing the driving mode of autonomous driving.

On the other hand, when the mode change processor 154 determines that the calculated angle θ is equal to or greater than the predetermined threshold value, the mode change processor 154 changes the driving mode to an autonomous driving mode with a lower control level (step S112). For example, when the driving mode of the host vehicle M is the mode A or the mode B, the mode change processor 154 changes the driving mode to the mode C, the mode D, or the mode E which has a lower control level than in the mode B. In other words, when the driving mode of the host vehicle M is the mode A or the mode B, the mode change processor 154 selects the mode C, the mode D, or the mode E in which a responsibility (tasks) imposed on an occupant is heavier than in the mode B.

As described above, the mode A and the mode B are modes in which an occupant is not obliged to hold the steering wheel 82. On the other hand, the modes C, D, and E are modes in which an occupant is obliged to hold the steering wheel 82. Thus, when the mode change processor 154 determines that the calculated angle θ is equal to or greater than the predetermined threshold value, the mode change processor 154 changes the driving mode of the host vehicle M to a mode in which an occupant is obliged to hold the steering wheel 82. Thereby, the processing of this flowchart is terminated.

[Abnormality Determination Processing (2) Performed by First Controller]

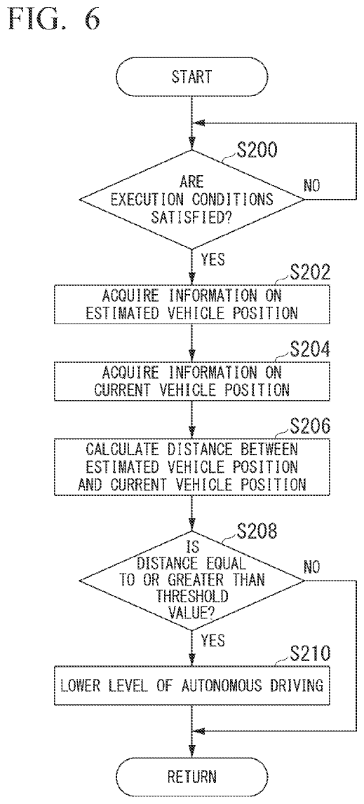

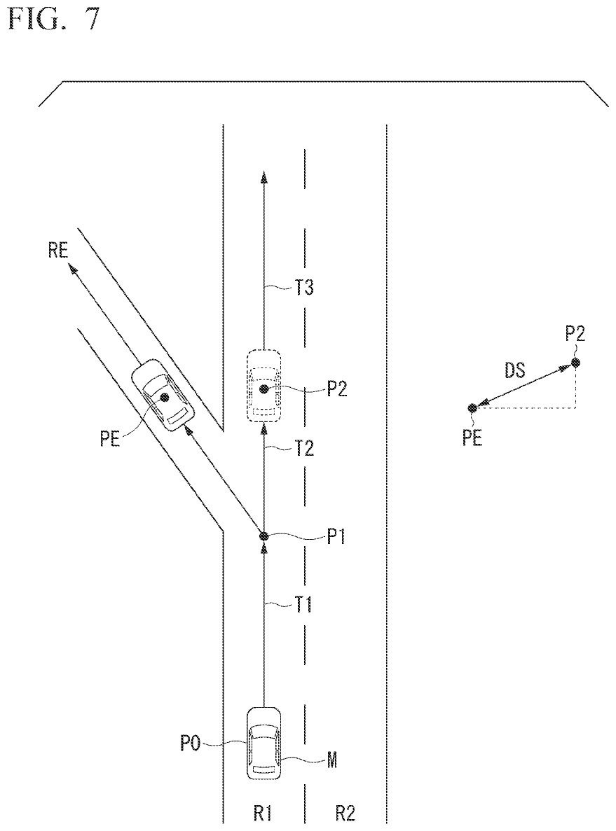

Another example of abnormality determination processing of the first controller 120 will be described below using a flowchart. FIG. 6 is a flowchart showing another example of abnormality determination processing performed by the first controller 120. FIG. 7 is a diagram showing another example of a scene in which an abnormality has occurred in a running state of the host vehicle M. In the following description, it is assumed that the host vehicle M is running in a driving mode determined by the mode determiner 150 (for example, the mode A or the mode B) under autonomous driving control along a target trajectory generated by the action plan generator 140. In addition, a case where information on an estimated vehicle position of the host vehicle M which is specified by the action plan generator 140 is used to calculate an index value will be described as an example.

First, the mode determiner 150 waits until execution conditions are satisfied (step S200). The execution conditions are conditions for executing the abnormality determination processing of this flowchart and include the following various conditions.
Condition (i): The autonomous driving control device 100 can acquire the second map information 62 from the MPU 60.
Condition (ii): The host vehicle M is not running in a prohibited section of the mode A or the mode B.
Condition (iii): No abnormality occurs in processing using the second map information 62 in the autonomous driving control device 100.

When the execution conditions are satisfied, the acquirer 156 of the mode determiner 150 acquires information on the estimated vehicle position of the host vehicle M which is specified by the action plan generator 140 (step S202).

Furthermore, the acquirer 156 acquires information on the current vehicle position of the host vehicle M which is measured by the GNSS receiver 51 (step S204).

Next, the index value calculator 158 calculates a distance between the acquired estimated vehicle position and the acquired current vehicle position (step S206). The example shown in FIG. 6 shows a scene in which the host vehicle M running along the target trajectories T1, T2, and T3 set on the road R1 under autonomous driving control unintentionally deviates from the target trajectory at the point P1 and enters the road RE located on the left in a traveling direction. That is, the host vehicle M, which should have been positioned at the point P2 on the road R1 when the host vehicle M has been normally running along the target trajectory under autonomous driving control is actually positioned at the point PE on the road RE. In this case, the index value calculator 158 calculates a distance DS between the point P2 and the point PE.

Next, the mode change processor 154 determines whether the calculated distance DS is equal to or greater than a predetermined threshold value (step S208). The threshold value is set to a value with which it can be determined that the vehicle is running on a different road. When the calculated distance DS is equal to or greater than the threshold value, it can be determined that the vehicle is running on a different road (that is, it can be determined that there is a deviation between the estimated vehicle position and the current vehicle position and that an abnormality has occurred). On the other hand, when the calculated distance DS is not equal to or greater than the threshold value, it can be determined that the vehicle is running on the same road (that is, it can be determined that there is no deviation between the estimated vehicle position and the current vehicle position, and that no abnormality has occurred). When the mode change processor 154 determines that the calculated distance DS is not equal to or greater than the predetermined threshold value, the mode change processor 154 continues controlling the autonomous driving control in the current driving mode without changing the driving mode of autonomous driving.

On the other hand, when the mode change processor 154 determines that the calculated distance DS is equal to or greater than the predetermined threshold value, the mode change processor 154 changes the driving mode to the autonomous driving mode with a lower control level (step S210). For example, when the driving mode of the host vehicle M is the mode A or the mode B, the mode change processor 154 changes the driving mode to the mode C, the mode D, or the mode E which has a lower control level than in the mode B. In other words, when the driving mode of the host vehicle M is the mode A or the mode B, the mode change processor 154 selects the mode C, the mode D, or the mode E in which a responsibility (task) imposed on an occupant is heavier than in the mode B.

As described above, the mode A and the mode B are modes in which an occupant is not obliged to hold the steering wheel 82. On the other hand, the modes C, D, and E are modes in which an occupant is obliged to hold the steering wheel 82. Thus, when the mode change processor 154 determines that the calculated distance DS is equal to or greater than the predetermined threshold value, the mode change processor 154 changes the driving mode of the host vehicle M to a mode in which an occupant is obliged to hold the steering wheel 82. Thereby, the processing of this flowchart is terminated.

According to the embodiment described above, there are provided the index value calculator 158 (calculator) that calculates an index value indicating the accuracy of an estimated position of the host vehicle M according to the current running state of the host vehicle M and an estimated running state of the host vehicle M which is estimated in the control of the autonomous driving, and the mode change processor 154 (controller) that lowers the control level of autonomous driving when the calculated index value is equal to or greater than a predetermined threshold, and thus it is possible to accurately ascertain the running state of a vehicle and change the control level of autonomous driving under appropriate conditions.

The embodiment described above can be expressed as follows.

A vehicle control device that controls autonomous driving of a vehicle, the vehicle control device including:
a storage device that stores a program; and
a hardware processor,
wherein the hardware processor executes the program to calculate an index value indicating accuracy of an estimated position of the vehicle according to the current running state of the vehicle and an estimated running state of the vehicle which is estimated in the control of the autonomous driving, and to lower a control level of the autonomous driving when the calculated index value is equal to or greater than a predetermined threshold.

Although a mode for carrying out the present invention has been described above using the embodiment, the present invention is not limited to such an embodiment at all, and various modifications and replacements can be made without departing from the scope of the present invention.

### REFERENCE SIGNS LIST

10 Camera
12 Radar device
14 LIDAR
16 Object recognition device
20 Communication device
30 HMIs
40 Vehicle sensor
50 Navigation device
51 GNSS receiver
52 Navigation HMI
53 Route determiner
54 First map information
60 MPU
61 Recommended lane determiner
62 Second map information
70 Driver monitor camera
82 Steering wheel
84 Steering holding sensor
100 Autonomous driving control device
120 First controller
130 RECOGNIZER
140 ACTION PLAN GENERATOR
150 Mode determiner
152 Driver state determiner
154 Mode change processor
156 Acquirer
158 Index value calculator
160 Second controller
162 Acquirer
164 Speed controller
166 Steering controller
200 Running driving force output device
210 Brake device
220 Steering device

What is claim is:

1. A vehicle control device that controls autonomous driving of a vehicle, the vehicle control device comprising:
a calculator configured to calculate an index value indicating accuracy of an estimated position of the vehicle according to a current running state of the vehicle and an estimated running state of the vehicle which is estimated in the control of the autonomous driving; and
a controller configured to lower a control level of the autonomous driving when the calculated index value is equal to or greater than a predetermined threshold value.

2. The vehicle control device according to claim 1,
wherein the calculator calculates an angle formed by a current traveling direction of the vehicle and a traveling direction of a target trajectory which is set in the control of the autonomous driving as the index value, and
the controller lowers the control level of the autonomous driving when the calculated angle is equal to or greater than a predetermined threshold value.

3. The vehicle control device according to claim 1,
wherein the calculator calculates an angle formed by a current traveling direction of the vehicle and a traveling direction of a recommended lane in the control of the autonomous driving as the index value, and
the controller lowers the control level of the autonomous driving when the calculated angle is equal to or greater than a predetermined threshold value.

4. The vehicle control device according to claim 1,
wherein the calculator calculates an angle formed by a current traveling direction of the vehicle and a traveling direction of a running lane recognized according to surroundings information of the vehicle in the control of the autonomous driving as the index value, and
the controller lowers the control level of the autonomous driving when the calculated angle is equal to or greater than a predetermined threshold value.

5. The vehicle control device according to claim 2, wherein the calculator calculates the current traveling direction of the vehicle according to radio waves arriving from a satellite.

6. The vehicle control device according to claim 1,
wherein the calculator calculates a distance between a current position of the vehicle and the estimated position of the vehicle on a map estimated in the control of the autonomous driving as the index value, and
the controller lowers the control level of the autonomous driving when the calculated distance is equal to or greater than a predetermined threshold value.

7. The vehicle control device according to claim 6, wherein the calculator calculates the current position of the vehicle according to radio waves arriving from a satellite.

8. A vehicle control method comprising:
causing a computer mounted on a vehicle to
calculate an index value indicating accuracy of an estimated position of the vehicle according to a current running state of the vehicle and an estimated running state of the vehicle which is estimated in the control of the autonomous driving of the vehicle, and
lower a control level of the autonomous driving when the calculated index value is equal to or greater than a predetermined threshold value.

9. A non-transitory computer readable storage medium storing a program causing a computer mounted on a vehicle to
calculate an index value indicating accuracy of an estimated position of the vehicle according to a current running state of the vehicle and an estimated running state of the vehicle which is estimated in the control of the autonomous driving of the vehicle, and
lower a control level of the autonomous driving when the calculated index value is equal to or greater than a predetermined threshold value.
